(19) United States
(12) Patent Application Publication
(10) Pub. No.: US 2011/0149212 A1
(43) Pub. Date: Jun. 23, 2011

(54) DISPLAY DEVICE AND LIQUID CRYSTAL DISPLAY APPARATUS

(75) Inventor: Junji TOMITA, Kawasaki (JP)

(73) Assignee: FUJITSU LIMITED, Kawasaki-shi (JP)

(21) Appl. No.: 12/965,884

(22) Filed: Dec. 12, 2010

(30) Foreign Application Priority Data
Dec. 18, 2009 (JP) 2009-288240

(51) Int. Cl. G02F 1/1335

(52) U.S. Cl. 349/98

(57) ABSTRACT

A liquid crystal display apparatus includes a compound device, a color display device, a driver, and a control circuit. The color display device includes three liquid crystal panels. The liquid crystal display apparatus has a layered structure in which the compound device is layered on the display surface of the color display device.

### CROSS-REFERENCE TO RELATED APPLICATION

This application is based upon and claims the benefit of priority of the prior Japanese Patent Application No. 2009-288240, filed on Dec. 18, 2009, the entire contents of which are incorporated herein by reference.

### FIELD

The embodiments discussed herein are directed to a display device and a liquid crystal display apparatus.

### BACKGROUND

Recent technological development of display devices has been actively carried out. An example is electric paper, which can keep its display without a power supply and is rewritable with low power consumption. Applications of electric paper in electric books, electric newspapers, and electric posters are also under development. Among technologies for electric paper, technological development of liquid crystal display devices that selectively reflect light (hereinafter, “selective-reflection liquid crystal device”) has been actively carried out. A selective-reflection liquid crystal display device achieves color display using interference reflection between liquid crystal panels.

In a selective-reflection liquid crystal display device, liquid crystal panels containing cholesteric liquid crystals are layered. For example, a liquid crystal display device includes a liquid crystal panel that selectively reflects light in the blue wavelength band from light in each wavelength band of the three primary colors (i.e., red, green, and blue), a liquid crystal panel that selectively reflects light in the green wavelength band, and a liquid crystal panel that selectively reflects light in the red wavelength band.

In a selective reflection liquid crystal display device, the wavelength band of light that is reflected by the liquid crystal panel shifts to a shorter wavelength band in accordance with the angle at which light is incident on the display surface. When the wavelength band of light that is reflected by the liquid crystal panel shifts to the shorter wavelength band, light in a band other than that of light that is selectively reflected by the liquid crystal panel is reflected, i.e., noise light is reflected. Light, in a wavelength band that is adjacent to the wavelength band of light to be selectively reflected by the liquid crystal panel and that has shorter wavelengths than those of the wavelength band of the light to be selectively reflected, is reflected as noise light.

FIG. 13 is a diagram illustrating the display quality of a conventional selective-reflection liquid crystal display device. FIG. 13 illustrates a cross section of a liquid crystal panel X of a liquid crystal display device and also illustrates the reflection of light that is incident on a display surface S of the liquid crystal display device. For example, as the angle at which light that is incident on the display surface S of the liquid crystal display device increases, the wavelength band of the light to be reflected by the liquid crystal panel X shifts to the a shorter wavelength band.

For example, it is supposed that an angle formed between the direction of the arrow in FIG. 13 and the direction perpendicular to the display surface S of the liquid crystal panel X is an angle of incidence. In this case, the angle of incidence of light that is incident on the display surface S of the liquid crystal display device in the direction of the dotted arrow in FIG. 13 is larger than the angle of incidence of light that is incident on the display surface S of the liquid crystal display device in the direction of the solid arrow in FIG. 13. Thus, noise light is more reflected when light is incident in the direction of the dotted arrow in FIG. 13 than in the direction of the solid arrow in FIG. 13.

For example, it is assumed that the liquid crystal panel X illustrated in FIG. 13 is a liquid crystal panel that selectively reflects light in the red wavelength band, and a setting is made such that the liquid crystal display device that includes the liquid crystal panel X displays red. When light that is incident in the direction of the dotted arrow in FIG. 13 is reflected by the liquid crystal panel X, the reflected light contains, in addition to light in the red wavelength band, light in the green wavelength band as noise light. For example, the wavelength band of light corresponding to red is about 700 to 600 nm and the wavelength band of light corresponding to green is about 500 to 600 nm, i.e., these wavelength bands are adjacent to each other. For this reason, green light in the wavelength band that is adjacent to the wavelength band of red light may be reflected by the liquid crystal panel that selectively reflects light in the red wavelength band depending on the angle of incidence of light. Accordingly, even when the color to be displayed by the liquid crystal display device is set as red, green may be displayed together with red, which deteriorates the display quality.

Technologies in which a color filter is disposed on a liquid crystal panel in order to prevent deterioration in display quality have been proposed. For example, such a color filter absorbs the above-described noise light from the light that is reflected by the liquid crystal panel.

FIG. 14 is a diagram of a conventional liquid crystal display device that includes color filters. FIG. 14 illustrates a cross section of a liquid crystal display device 200. In the liquid crystal display device illustrated in FIG. 14, a liquid crystal panel 230, a color filter 200Y, a liquid crystal panel 220, a color filter 200X, and a liquid crystal panel 210 are layered in the order that they appear in this sentence toward the side of the display surface S of the liquid crystal display device illustrated in FIG. 14.

The liquid crystal panel 210 illustrated in FIG. 14 selectively reflects light in the blue wavelength band. The liquid crystal panel 220 selectively reflects light in the green wavelength band. The liquid crystal panel 230 selectively reflects light in the red wavelength band. The color filter 200X absorbs light in the blue wavelength band, which has shorter wavelengths than those of the green wavelength band. The color filter 200Y absorbs light in the green wavelength band, which has shorter wavelengths than those of the red wavelength band.

In the liquid crystal display device illustrated in FIG. 14, the color filter 200X is disposed on a surface opposing the display surface S of the liquid crystal display device, i.e., on the upper surface of the liquid crystal panel 220. Furthermore, in the liquid crystal display device illustrated in FIG. 14, the color filter 200Y is disposed on the upper surface of a surface opposing the display surface S of the liquid crystal display device, i.e., on the upper surface of the liquid crystal panel 230. The color filter 200X absorbs light in the blue wavelength band that is reflected as noise light from the liquid crystal panel 220. The color filter 200Y absorbs light in the green wavelength band that is reflected as noise light from the liquid crystal panel 230.

FIGS. 15 and 16 are graphs representing the light reflective characteristics of a liquid crystal panel with a color filter. The horizontal axis of the graphs of FIGS. 15 and 16 represents the wavelength of light and the vertical axis represents the light reflection intensity. FIG. 15 represents the light reflective characteristics of the liquid crystal panel 220, illustrated in FIG. 14, with the color filter 200X being disposed on the upper surface of the liquid crystal panel 220. The reference numeral 15a represented in FIG. 15 denotes a curved line representing the light reflective characteristics of the liquid crystal panel 220 without any color filter. The reference numeral 15b represented in FIG. 15 denotes a curved line representing the light reflective characteristics of the liquid crystal panel 220 with the color filter.

FIG. 16 represents the light reflective characteristics of the liquid crystal panel 230, illustrated in FIG. 14, with the color filter 200Y being disposed on the upper surface of the liquid crystal panel 230. The reference numeral 16a represented in FIG. 16 denotes a curved line representing the light reflective characteristics of the liquid crystal panel 230 without any color filter. The reference numeral 16b represented in FIG. 16 denotes a curved line representing the light reflective characteristics of the liquid crystal panel 230 with the color filter.

As illustrated in FIG. 15, the liquid crystal panel 220 with the color filter 200X being disposed on the upper surface of the liquid crystal panel 220 reduces noise light that is reflected from the liquid crystal panel 220, i.e., light in the blue wavelength band. The blue wavelength band is about 400 to 500 nm.

As illustrated in FIG. 16, the liquid crystal panel 230 with the color filter 200Y disposed on the upper surface on the liquid crystal panel 230 reduces noise light that is reflected from the liquid crystal panel 230, i.e., reflection of light in the green wavelength band. As described above, the technology in which color filters are disposed prevents deterioration of display quality due to changes in the angle of incidence of light on the display surface. The green wavelength band is about 500 to 600 nm.

The problem with the above-described technology in which color filters are disposed is that it requires a step of disposing color filters during manufacture. In the case illustrated in FIG. 14, for example, a step is required for disposing a color filter between the liquid crystal panel 230 and the liquid crystal panel 220 and between the liquid crystal panel 220 and the liquid crystal panel 210; therefore, while deterioration in image quality is prevented, the step of disposing color filters increases the number of steps and thus increases the cost of manufacturing a liquid crystal display device.

If, due to costs, the same adhesive materials cannot be used for adhering a liquid crystal panel, a color filter, a liquid crystal panel, and a color filter, it is difficult to obtain perfectly uniform refractive indexes between the liquid crystal panels and the color filters. Furthermore, a light reflection loss occurs due to the color filters. Because of a difference in the refractive indexes between the liquid crystal panels and the color filters and the light reflection loss due to the color filters, the contrast of the color displayed on the liquid crystal display device lowers. This leads to a problem in that, with the above-described technology in which color filters are disposed, the display quality deteriorates significantly.

Patent Document: Japanese Patent No. 3651611

### SUMMARY

According to an aspect of an embodiment of the invention, a display device includes an optical device that absorbs non-linear light and non-linear light that are opposed to each other in at least two wavelength bands; and a liquid crystal display device that selectively reflects non-linear polarized light transmitted by the optical device, in at least three wavelength bands, wherein the optical device is disposed on a display surface of the liquid crystal display device.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram of a liquid crystal display apparatus according to a first embodiment;

FIG. 2 is a diagram of a compound device according to the first embodiment;

FIG. 3 is a graph of the optical transmission characteristics of a polarizer according to the first embodiment;

FIG. 4 is a diagram illustrating circular polarized light that is transmitted from a phase difference plate according to the first embodiment;

FIG. 5 is a graph of the optical transmission characteristics of the phase difference plate according to the first embodiment;

FIG. 6 is a graph of the optical transmission characteristics of a phase difference plate according to the first embodiment;

FIG. 7 is a diagram illustrating light reflection by the liquid crystal display apparatus according to the first embodiment;

FIG. 8 is a graph of the light reflective characteristics of the liquid crystal display apparatus according to the first embodiment;

FIG. 9 is a graph of the light reflective characteristics of the liquid crystal display apparatus according to the first embodiment;

FIG. 10 is a chart of a process of manufacturing a liquid crystal display apparatus according to the first embodiment;

FIG. 11 is a diagram illustrating light reflection by a liquid crystal display apparatus according to a second embodiment;

FIG. 12 is a diagram illustrating light reflection by a liquid crystal display apparatus according to the second embodiment;

FIG. 13 is a diagram illustrating the display quality of a conventional selective-reflection liquid crystal display device;

FIG. 14 is a diagram of a conventional liquid crystal display device that includes color filters;

FIG. 15 is a graph of the light reflective characteristics of a liquid crystal panel with a color filter; and

FIG. 16 is a diagram of the light reflective characteristics of a liquid crystal panel.

### DESCRIPTION OF EMBODIMENTS

Preferred embodiments of the present invention will be explained with reference to accompanying drawings. The embodiments do not limit the technology disclosed in this application.

[a] First Embodiment

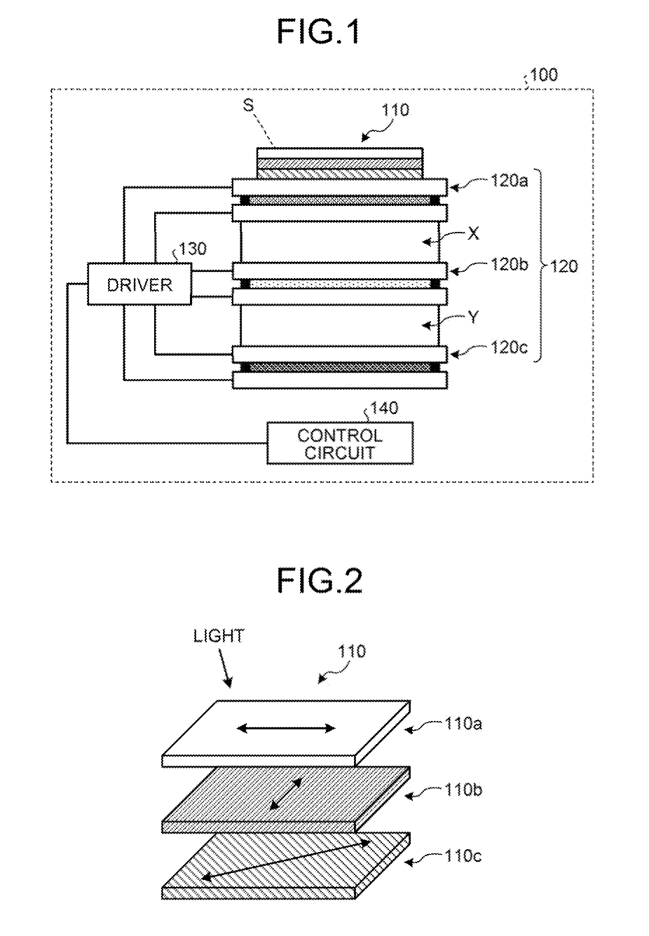

FIG. 1 is a diagram of a liquid crystal display apparatus according to a first embodiment of the present invention. As illustrated in FIG. 1, a liquid crystal display apparatus 100 according to the first embodiment includes a compound device 110, a color display device 120, a driver 130, and a control circuit 140. The color display device 120 includes a liquid crystal panel 120a, a liquid crystal panel 120b, and a liquid crystal panel 120c. The reference symbol S represented in FIG. 1 denotes the liquid crystal display surface. FIG. 1 illustrates a cross section of the color display device 120. The display surface is a surface on which final color display is achieved using light that is selectively reflected by the liquid crystal panel 120a, the liquid crystal panel 120b, and the liquid crystal panel 120c. Alternatively, the display surface means the direction, out of the directions in which light is incident on the liquid crystal panel 120a, in which light is incident and thus the liquid crystal panel 120a can fulfill the function of displaying colors.

The liquid crystal display apparatus 100 has a structured in which the compound device 110 is layered on the display surface of the color display device 120. The color display device 120 is manufactured in a way that the liquid crystal panel 120c and the liquid crystal panel 120b are adhered using an adhesive layer Y and thus are layered and the liquid crystal panel 120b and the liquid crystal panel 120a are then adhered using an adhesive layer X and thus are layered. The color display device 120 is a layered device that includes the layered liquid crystal panels 120a to 120c.

Each of the liquid crystal panels 120a to 120c is manufactured by accumulating liquid crystal material, such as cholesteric liquid crystals, that correspond to the wavelength bands of light that are to be selectively reflected and by sandwiching the accumulated liquid crystals between substrates. The direction in which the liquid crystals twist is determined in accordance with the characteristics of circular polarized light that is selectively reflected. The characteristics of circular polarized light are characteristics that are determined as either clockwise or anticlockwise circular polarized light. It is desirable that the refractive index of an acrylic adhesive that serves as an adhesive layer X and an adhesive layer Y be equal to the refractive index of the acrylic substrates of the liquid crystal panels 120a to 120c.

The driver 130 applies a voltage to the liquid crystal panels 120a to 120c of the color display device 120 according to control signals from the control circuit 140. The control circuit 140 outputs, to the driver 130, control signals for controlling the liquid crystal panels 120a to 120c of the color display device 120 such that light is reflected or transmitted.

FIG. 2 is a diagram of the compound device according to the first embodiment. As illustrated in FIG. 2, the compound device 110 according to the first embodiment includes a color polarizer 110a, a color polarizer 110b, and a phase difference plate 110c. As illustrated in FIG. 2, in the compound device 110, the color polarizer 110a, the color polarizer 110b, and the phase difference plate 110c are disposed in the order that they appear in this sentence. However, the order is not limited to this. The color polarizer 110a, the color polarizer 110b, and the phase difference plate 110c may be disposed in any order.

The color polarizer 110a is a polarizer containing, for example, dye or iodine. The arrow on the color polarizer 110a represented in FIG. 2 indicates the direction of linear polarized optical components to be transmitted from light of linear polarized optical components that belong to the wavelength band corresponding to blue. The color polarizer 110a transmits light of linear polarized optical components in the direction indicated by the arrow in FIG. 2 from the light of the linear polarized optical components in the wavelength band corresponding to blue. The color polarizer 110a transmits all light in wavelength bands corresponding to colors other than blue.

Similar to the color polarizer 110a, the color polarizer 110b is a polarizer containing, for example, dye or iodine. The arrow on the color polarizer 110b represented in FIG. 2 indicates the direction of linear polarized optical components to be transmitted from light of linear polarized optical components that belong to the wavelength band corresponding to green. The color polarizer 110b transmits light of linear polarized optical components in the direction indicated by the arrow in FIG. 2 from the light of the linear polarized optical components in the wavelength band corresponding to green. The color polarizer 110b transmits all light in wavelength bands corresponding to colors other than green.

The light of the blue linear polarized optical components that are transmitted from the color polarizer 110a and the light of the linear polarized optical components that are transmitted from the color polarizer 110b have linear polarization directions that are opposed to each other, i.e., polarization directions orthogonal to each other. For example, if the polarization direction of light of the blue linear polarized optical components that are transmitted from the color polarizer 110a is 90 degrees, the polarization direction of the light of the blue linear polarized optical components that is transmitted from the color polarizer 110b is 0 degrees.

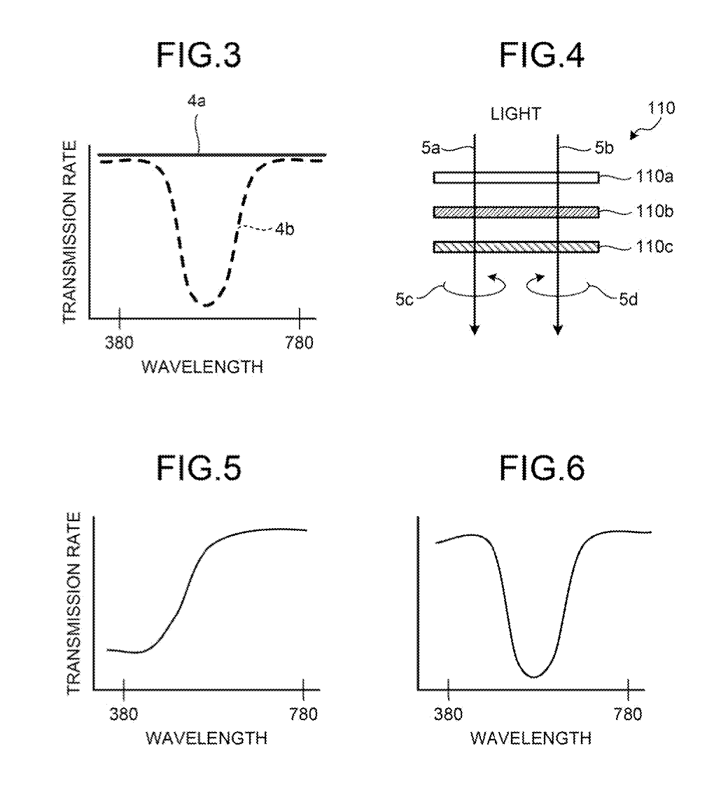

FIG. 3 is a graph of the optical transmission characteristics of the polarizer according to the first embodiment. FIG. 3 represents the optical transmission characteristics of the color polarizer 110b as an example of optical transmission characteristics of a polarizer. The vertical axis in FIG. 3 represents the transmission rate of light and the horizontal axis in FIG. 3 represents the wavelength of transmitted light. The reference numeral 4a in FIG. 3 denotes 0-degree linear polarized light and the reference numeral 4b in FIG. 3 denotes 90-degree linear polarized light.

As illustrated in FIG. 3, while the color polarizer 110b transmits linear polarized light having the 0-degree polarization direction from light of linear polarized optical components that belong to the wavelength band of light corresponding to green, the color polarizer 110b absorbs linear polarized light having the 90-degree polarization direction. In other words, the color polarizer 110b transmits only linear polarized light having the 0-degree polarization direction from light that belongs to the wavelength band of light corresponding to green. The wavelength band of light corresponding to green is, for example, 400 to 500 nm.

Although the optical transmission characteristics are not represented in the drawings, the color polarizer 110a transmits, from light that belongs to the wavelength band of light corresponding to blue, only linear polarized light having the polarization direction opposed to the linear polarized optical components that are transmitted by the color polarizer 110b, i.e., having the 90-degree polarization direction. In the color polarizers 110a and 110b, color components are arranged in a predetermined direction for anisotropy so that the color polarizers 110a and 110b transmit or absorb light having a desired linear polarization direction from incident light.

The phase difference plate 110c is an anisotropic or isotropic crystal plate. The arrow on the phase difference plate 110c in FIG. 2 indicates the direction in which, when light of orthogonal polarized optical components is transmitted, adjustment is made to provide a predetermined phase difference in the transmitted light. If the phase difference plate 110c is a phase difference plate of ¼×λ, when linear polarized light and linear polarized light, which are orthogonal to each other are transmitted, the transmitted linear polarized light is converted to circular polarized light and circular polarized light that are opposed to each other by providing a phase difference of π/2 in the transmitted light.

FIG. 4 is a diagram illustrating circular polarized light that is transmitted from the phase difference plate according to the first embodiment. FIG. 4 separately illustrates a transmission path 5a of linear polarized light having the 0-degree polarization direction and a transmission path 5b of linear polarized light having the 90-degree polarization direction. In addition, the reference numeral 5c in FIG. 4 denotes anticlockwise circular polarized light and the reference numeral 5d in FIG. 4 denotes clockwise circular polarized light.

As the reference numeral 5c in FIG. 4 indicates, when linear polarized light having the 0-degree polarization direction is transmitted, the phase difference plate 110c converts the linear polarized light to anticlockwise circular polarized light. For example, the color polarizer 110b transmits, from light that belongs to the wavelength band of light corresponding to green, only linear polarized light having the 0-degree polarization direction. Accordingly, the light that the phase difference plate 110c transmits from the linear polarized light having the 0-degree polarization direction is only anticlockwise circular polarized light that belongs to the wavelength band of light corresponding to green and anticlockwise circular polarized light that belongs to the wavelength band of light corresponding to red.

As the reference numeral 5d in FIG. 4 indicates, when linear polarized light having the 90-degree polarization direction is transmitted, the phase difference plate 110c converts the linear polarized light to clockwise circular polarized light. For example, the color polarizer 110a transmits, from light that belongs to the wavelength band of light corresponding to blue, only linear polarized light having the 90-degree polarization direction. Accordingly, the light that the phase difference plate 110c transmits from the linear polarized light having the 90-degree polarization direction is only clockwise circular polarized light that belongs to the wavelength band of light corresponding to blue and anticlockwise circular polarized light that belongs to the wavelength band of light corresponding to red.

FIGS. 5 and 6 are graphs of optical transmission characteristics of the phase difference plate according to the first embodiment. The vertical axis in FIGS. 5 and 6 represent the transmission rate of light and the horizontal axis in FIGS. 5 represents the optical transmission characteristics of the phase difference plate with respect to clockwise circular polarized light. FIG. 6 represents the optical transmission characteristics of the phase difference plate with respect to anticlockwise circular polarized light.

As illustrated in FIG. 5, the phase difference plate 110c does not transmit, from clockwise circular polarized light, circular polarized light that belongs to the wavelength band of light corresponding to blue. In addition, as illustrated in FIG. 6, the phase difference plate 110c does not transmit, from anticlockwise circular polarized light, circular polarized light that belongs to the wavelength band of light corresponding to green. With respect to circular polarized light that belongs to the wavelength band of light corresponding to red, the phase difference plate 110c transmits both clockwise and anticlockwise circular polarized light.

To sum up, when the compound device 110 receives light, the compound device 110 transmits the clockwise circular polarized light that belongs to the wavelength band of light corresponding to blue, transmits the anticlockwise circular polarized light that belongs to the wavelength band of light corresponding to green, and transmits clockwise and anticlockwise circular polarized light that belongs to the wavelength band of light corresponding to red.

Because the polarization directions of the color polarizer 110a and the color polarizer 110b and the phase difference adjustment direction of the phase difference plate 110c are combined as illustrated in FIG. 2, the compound device 110 determines circular polarized light to be transmitted according to each light wavelength. For this reason, by setting polarized directions that are opposite to each other in the color polarizer 110a and the color polarizer 110b or by changing the phase difference adjustment direction in a range of ±45 degrees, circular polarized light to be transmitted can be polarized in accordance with each light wavelength.

The liquid crystal panel 120a illustrated in FIG. 1 reflects the clockwise circular polarized light that belongs to the wavelength band of light corresponding to blue. The liquid crystal panel 120a transmits the anticlockwise circular polarized light that belongs to the wavelength band of light corresponding to green and the clockwise and anticlockwise circular polarized light that belongs to the wavelength band of light corresponding to red.

The liquid crystal panel 120b illustrated in FIG. 1 reflects the anticlockwise circular polarized light that belongs to the wavelength band of light corresponding to green. The liquid crystal panel 120b transmits the clockwise and anticlockwise circular polarized light that belongs to the wavelength band of light corresponding to red.

The liquid crystal panel 120c illustrated in FIG. 1 reflects the anticlockwise circular polarized light that belongs to the wavelength band of light corresponding to red. The liquid crystal panel 120c transmits the clockwise circular polarized light that belongs to the wavelength band of light corresponding to red.

Any well-known technology may be used for the liquid crystal panels 120a to 120c such that predetermined circular polarized light in predetermined wavelength bands is transmitted. For example, cholesteric liquid crystals that are used for the liquid crystal panels 120a to 120c usually have a spiral structure in which the direction orthogonal to the substrates of liquid crystal panels is the spiral axis and multiple layers of stick-shaped molecules are twisted regularly. The spiral structure of cholesteric liquid crystals is made by achieving optical rotation by adding additives, called chiral agents, to nematic liquid crystals that have no layered structure and parallel sequences. The direction about the spiral axis in which each layer of cholesteric liquid crystals is twisted and the direction of reflected circular polarized light are determined according to the type of the chiral agent that is added to the nematic liquid crystals.

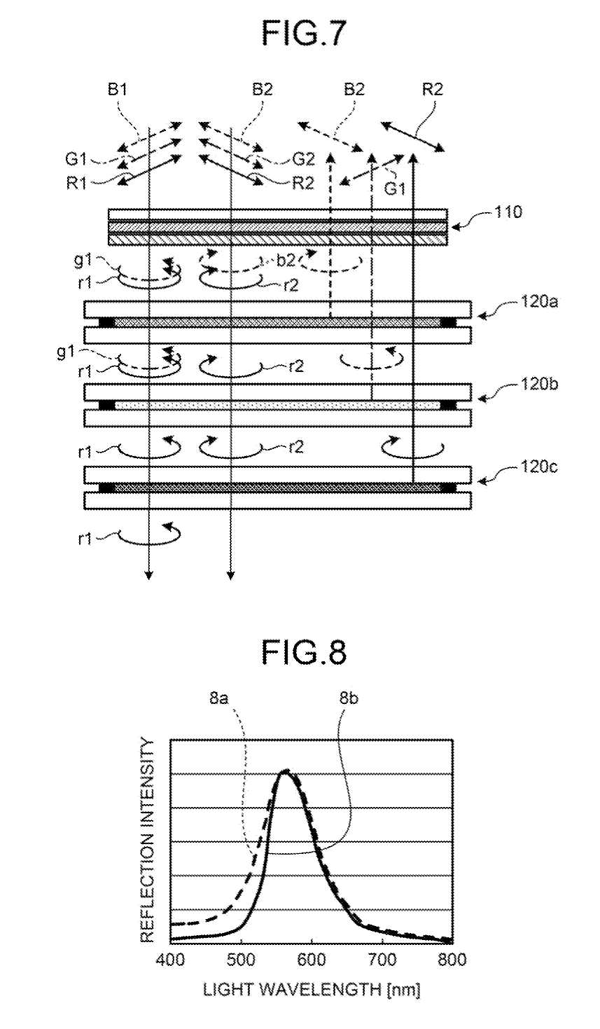

FIG. 7 is a diagram illustrating light reflection by the liquid crystal display apparatus according to the first embodiment. FIG. 7 illustrates a cross section of the compound device 110 and the color display device 120. The five arrows that are vertically drawn on the cross section indicate light transmission paths and light reflection paths.

Among the five arrows in FIG. 7, the leftmost arrow indicates the transmission path of linear polarized light having the 0-degree polarization direction. The second leftmost arrow indicates the transmission path of linear polarized light having the 90-degree polarization direction. The third rightmost arrow indicates the reflection path of light that is reflected by the liquid crystal panel 120a. The second rightmost arrow indicates the reflection path of light that is reflected by the liquid crystal panel 120b. The rightmost arrow indicates the reflection path of light that is reflected by the liquid crystal panel 120c.

Each of the arrows that are presented above the compound device 110 in FIG. 7 indicates any one of linear polarized light in each wavelength band having the 0-degree polarization direction and linear polarized light in each wavelength band having the 90-degree polarization direction.

For example, the arrow B1 that is presented above the compound device 110 in FIG. 7 indicates the linear polarized light having the 0-degree polarization direction from light that belongs to the wavelength band of light corresponding to blue. The arrow B2 that is drawn above the compound device 110 indicates the linear polarized light having the 90-degree polarization direction from light that belongs to the wavelength band of light corresponding to blue.

The arrow G1 that is presented above the compound device 110 in FIG. 7 indicates the linear polarized light having the 0-degree polarization direction from light that belongs to the wavelength band of light corresponding to green. The arrow G2 that is presented above the compound device 110 indicates the linear polarized light having the 90-degree polarization direction from light that belongs to the wavelength band of light corresponding to green.

The arrow R1 that is presented above the compound device 110 in FIG. 7 indicates the linear polarized light having the 0-degree polarization direction from light that belongs to the wavelength band of light corresponding to red. The arrow R2 that is presented above the compound device 110 indicates the linear polarized light having the 90-degree polarization direction from light that belongs to the wavelength band of light corresponding to red.

The curved arrows that are presented between the compound device 110 and the liquid crystal panel 120a, between the liquid crystal panel 120a and the liquid crystal panel 120b, between the liquid crystal panel 120b and the liquid crystal panel 120c, and below the liquid crystal panel 120c in FIG. 7 indicate circular polarized light having predetermined characteristics.

For example, the arrow b2 that is presented between the compound device 110 and the liquid crystal panel 120a in FIG. 7 indicates clockwise circular polarized light that belongs to the wavelength band of light corresponding to blue. The arrows g1 that are presented between the compound device 110 and the liquid crystal panel 120a and between the liquid crystal panel 120a and the liquid crystal panel 120b in FIG. 7 indicate anticlockwise circular polarized light that belongs to the wavelength band of light corresponding to green.

The arrows r1 that are presented between the compound device 110 and the liquid crystal panel 120a, between the liquid crystal panel 120a and the liquid crystal panel 120b, between the liquid crystal panel 120b and the liquid crystal panel 120c, and below the liquid crystal panel 120c in FIG. 7 indicate anticlockwise circular polarized light that belongs to the wavelength band of light corresponding to red. The arrows r2 that are presented between the compound device 110 and the liquid crystal panel 120a, between the liquid crystal panel 120a and the liquid crystal panel 120b, and between the liquid crystal panel 120b and the liquid crystal panel 120c in FIG. 7 indicate clockwise circular polarized light that belongs to the wavelength band of light corresponding to red.

As illustrated in FIG. 7, the compound device 110 receives 0-degree linear polarized light B1, G1, and R1 and transmits anticlockwise circular polarized light g1 and r1. The compound device 110 also receives 90-degree linear polarized light B2, G2, and R2 and transmits clockwise circular polarized light b2 and r2.

As illustrated in FIG. 7, the liquid crystal panel 120a reflects the clockwise circular polarized light b2 and transmits the anticlockwise circular polarized light g1 and r1 and the clockwise circular polarized light r2. The liquid crystal panel 120b reflects the anticlockwise circular polarized light g1 and transmits the anticlockwise circular polarized light r1 and r1 and the clockwise circular polarized light r2. The liquid crystal panel 120c reflects the clockwise circular polarized light r2 and transmits the anticlockwise circular polarized light r1.

As illustrated in FIG. 7, in the liquid crystal display apparatus 100, the characteristics of circular polarized light to be reflected are inverted between liquid crystal panels between which wavelength bands of light to be selectively reflected are adjacent to each other. For example, the liquid crystal panel 120a selectively reflects light in the wavelength band corresponding to blue and the liquid crystal panel 120b selectively reflects light in the wavelength band corresponding to green. The wavelength band of light corresponding to blue is about 400 to 500 nm and the wavelength band of light corresponding to green is about 500 to 600 nm; therefore, the wavelength bands of light to be selectively reflected are adjacent to each other between the liquid crystal panel 120a and the liquid crystal panel 120b. Thus, the characteristics of circular polarized light to be reflected by the liquid crystal panel 120a are clockwise and the characteristics of circular polarized light to be reflected by the liquid crystal panel 120b are anticlockwise.

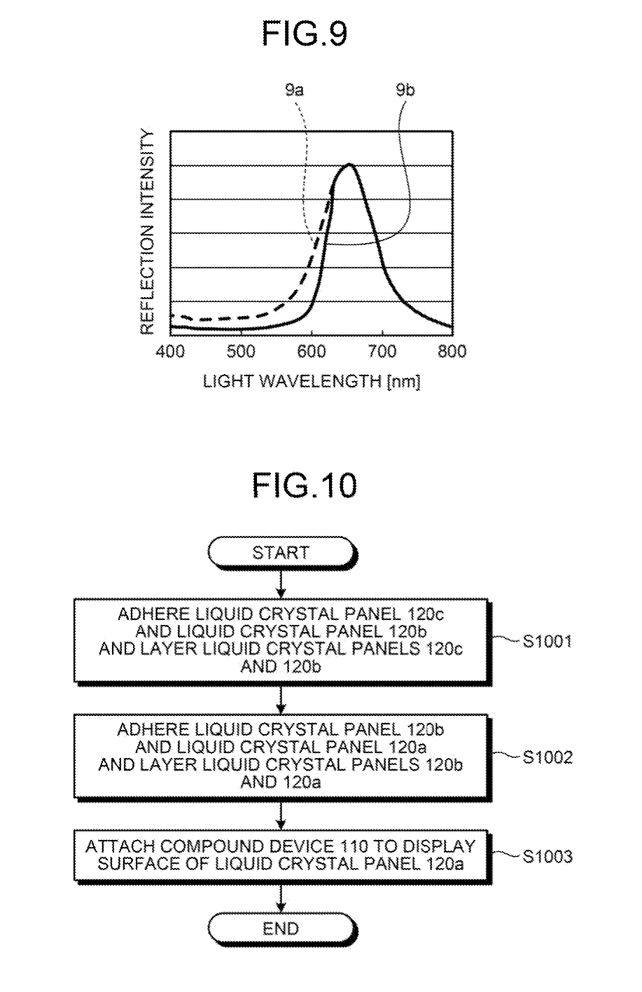

FIGS. 8 and 9 are graphs of the light reflective characteristics of the liquid crystal display apparatus according to the first embodiment. The vertical axis in FIGS. 8 and 9 represents the light reflection intensity and the horizontal axis in FIGS. 8 and 9 represents the wavelength of reflected light. FIG. 8 represents the light reflective characteristics of the liquid crystal panel 120b. The reference numeral 8a in FIG. 8 indicates the light reflective characteristics without the compound device 110, and the reference numeral 8b in FIG. 8 indicates the light reflective characteristics with the compound device 110. FIG. 9 represents the light reflective characteristics of the liquid crystal panel 120c. The reference numeral 9a in FIG. 9 represents the light reflective characteristics without the compound device 110, and the reference numeral 9b in FIG. 9 indicates the light reflective characteristics with the compound device 110.

As illustrated in FIG. 8, provision of the compound device 110 reduces light in the wavelength band corresponding to blue from light that is reflected by the liquid crystal panel 120b. For example, the wavelength band corresponding to blue is about 400 to 500 nm. In other words, provision of the compound device 110 inhibits occurrence of noise light on the liquid crystal panel 120b, which keeps the display quality when green is displayed.

As illustrated in FIG. 9, provision of the compound device 110 reduces light in the wavelength band corresponding to green from light that is reflected by the liquid crystal panel 120c. For example, the wavelength band corresponding to green is about 500 to 600 nm. In other words, provision of the compound device 110 inhibits occurrence of noise light on the liquid crystal panel 120c, which keeps the display quality when red is displayed.

FIG. 10 is a chart of a process of manufacturing a liquid crystal display apparatus according to the first embodiment. As illustrated in FIG. 10, the liquid crystal panel 120c and the liquid crystal panel 120b are adhered to each other with the adhesive layer Y for which, for example, an acrylic adhesive is used and thus are layered (step S1001). The liquid crystal panel 120b and the liquid crystal panel 120a are then adhered to each other with the adhesive layer X for which, for example, an acrylic adhesive is used and thus are layered (step S1002). The steps to step S1002 complete the color display device 120. The compound device 110 is then attached to the display surface of the color display device 120 (step S1003).

As described above, according to the first embodiment, the color polarizer 110a absorbs 0-degree linear polarized light from light in the wavelength band corresponding to blue and transmits 90-degree linear polarized light. The color polarizer 110b absorbs 90-degree linear polarized light from light in the wavelength band corresponding to green and transmits 0-degree linear polarized light. The phase difference plate 110c converts 90-degree linear polarized light in the wavelength band corresponding to blue to clockwise circular polarized light and converts 0-degree linear polarized light in the wavelength band corresponding to green to anticlockwise circular polarized light.

In other words, with respect to the wavelength band corresponding to blue and the wavelength band corresponding to green, the compound device 110 absorbs 0-degree linear polarized light from light in the wavelength band corresponding to blue and absorbs 90-degree linear polarized light from light in the wavelength band corresponding to green. According to the first embodiment, polarized optical components of light in the adjacent wavelength band, which cause noise light, from incident light can be absorbed.

The color display device 120 selectively reflects at least light in the wavelength band corresponding to blue, the wavelength band corresponding to green, and the wavelength band corresponding to red. The characteristics of circular polarized light to be reflected are inverted between liquid crystal panels between which wavelength bands of light to be selectively reflected are adjacent to each other.

For example, in the color display device 120, the liquid crystal panel 120a reflects clockwise circular polarized light that belongs to the wavelength band of light corresponding to blue, transmits anticlockwise circular polarized light that belongs to the wavelength band of light corresponding to green, and transmits clockwise and anticlockwise circular polarized light that belong to the wavelength band of light corresponding to red. The liquid crystal panel 120b reflects anticlockwise circular polarized light that belongs to the wavelength band of light corresponding to green and transmits clockwise and anticlockwise circular polarized light that belong to the wavelength band of light corresponding to red. The liquid crystal panel 120c reflects anticlockwise circular polarized light that belongs to the wavelength band of light corresponding to red and transmits clockwise circular polarized light that belongs to the wavelength band of light corresponding to red. According to the first embodiment, any loss of light in the overlapping wavelength bands of light to be selectively reflected can be reduced from the light that is reflected by each liquid crystal panel.

As described above, the liquid crystal display apparatus 100 according to the first embodiment can absorb polarized optical components of light in the adjacent wavelength bands that cause noise light. Furthermore, the liquid crystal display apparatus 100 can reduce the loss of light in the overlapping wavelength bands of light to be selectively reflected from the light that is reflected by each liquid crystal panel. In addition, because the liquid crystal display apparatus 100 is not provided with color filters between liquid crystal panels, a loss of reflection of light and a reduction in contrast can be avoided. Thus, according to the first embodiment, degradation in display quality can be prevented.

According to the first embodiment, as illustrated in FIG. 10, when manufacturing a liquid crystal display device, the step of disposing a color filter is unnecessary; therefore, according to the first embodiment, degradation in display quality can be prevented and the cost of manufacturing a liquid crystal device can be reduced.

According to the first embodiment, because a layered color display device in which the liquid crystal panels for the respective wavelength bands of light to be selectively reflected are disposed is used, the intensity of reflection of light in each of the wavelength bands can be maintained.

[b] Second Embodiment

(1) Single-layer Color Display Device

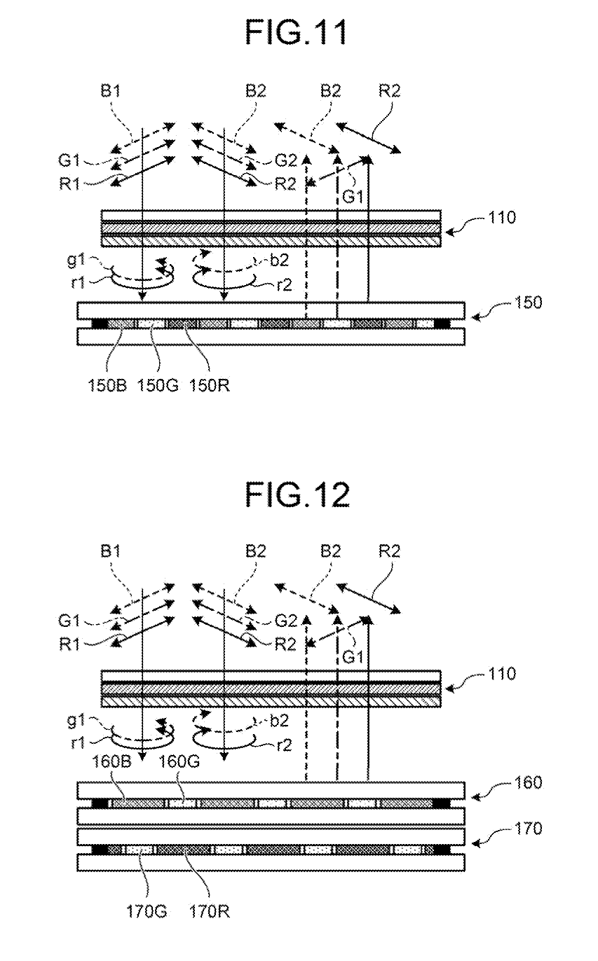

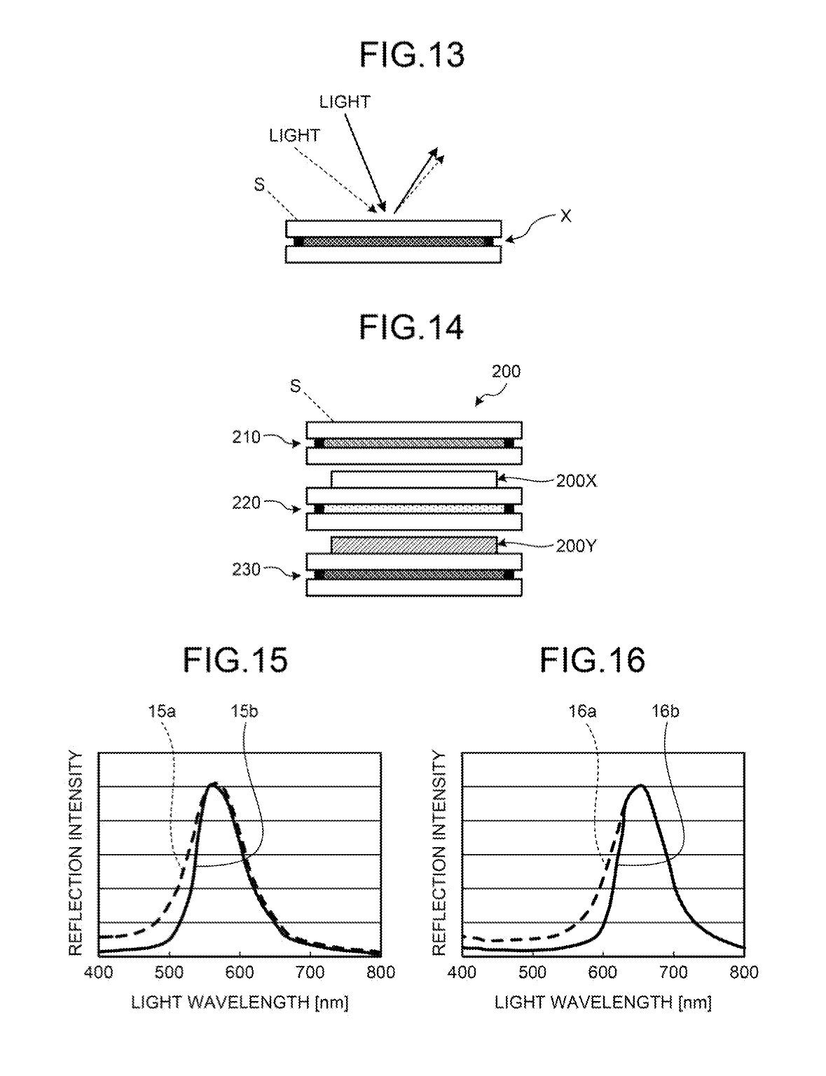

In the first embodiment, the case in which a layered color display device is used is described. Alternatively, a single-layer color display device may be used. FIG. 11 is a diagram illustrating reflection of light by a liquid crystal display apparatus according to a second embodiment of the present invention.

As illustrated in FIG. 11, the color display device according to the second embodiment includes a single-layer liquid crystal panel 150 in which liquid crystals 150B, liquid crystals 150G, and liquid crystals 150R are disposed dispersively.

The liquid crystal 150B illustrated in FIG. 11 reflects clockwise circular polarized light that belongs to the wavelength band of light corresponding to blue. The liquid crystal 150G reflects anticlockwise circular polarized light that belongs to the wavelength band of light corresponding to green. The liquid crystal 150R illustrated in FIG. 11 reflects clockwise circular polarized light that belongs to the wavelength band of light corresponding to red.

In the liquid crystal panel 150, the characteristics of circular polarized light to be reflected are inverted between liquid crystals between which wavelength bands of light to be selectively reflected are adjacent to each other. Specifically, the characteristics of circular polarized light to be reflected are inverted between the liquid crystal 150B and the liquid crystal 150G and between the liquid crystal 150G and the liquid crystal 150R.

FIG. 11 illustrates a cross section of the compound device 110 and the color display device. The five arrows that are vertically drawn on the cross section indicate light transmission paths and light reflection paths. Among the five arrows in FIG. 11, the leftmost arrow indicates the transmission path of linear polarized light having the 0-degree polarization direction.

The second leftmost arrow in FIG. 11 indicates the reflection transmission path of linear polarized light having the 90-degree polarization direction. The third rightmost arrow indicates the reflection path of light that is reflected by the liquid crystal panel 150.

The second rightmost arrow in FIG. 11 indicates a reflection path of light that is reflected by the liquid crystal panel 150. The rightmost arrow indicates a reflection path of light that is reflected by the liquid crystal panel 150.

Each of the arrows that are presented above the compound device 110 in FIG. 11 indicates any one of linear polarized light in each wavelength band having the 0-degree polarization direction and linear polarized light in each wavelength band having the 90-degree polarization direction.

For example, the arrow B1 that is presented above the compound device 110 in FIG. 11 indicates linear polarized light having the 0-degree polarization direction from light that belongs to the wavelength band of light corresponding to blue. The arrow B2 that is drawn above the compound device 110 indicates the linear polarized light having the 90-degree polarization direction from light that belongs to the wavelength band of light corresponding to blue.

The arrow G1 that is presented above the compound device 110 in FIG. 11 indicates the linear polarized light having the 0-degree polarization direction from light that belongs to the wavelength band of light corresponding to green. The arrow G2 that is drawn above the compound device 110 indicates the linear polarized light having the 90-degree polarization direction from light that belongs to the wavelength band of light corresponding to green.

The arrow R1 that is presented above the compound device 110 in FIG. 11 indicates the linear polarized light having the 0-degree polarization direction from light that belongs to the wavelength band of light corresponding to red. The arrow R2 that is drawn above the compound device 110 indicates the linear polarized light having the 90-degree polarization direction from light that belongs to the wavelength band of light corresponding to red.

The curved arrows that are presented between the compound device 110 and the liquid crystal panel 150 in FIG. 11 indicate circular polarized light having predetermined characteristics.

For example, the arrow b2 that is presented between the compound device 110 and the liquid crystal panel 150 in FIG. 11 indicates clockwise circular polarized light that belongs to the wavelength band of light corresponding to blue. The arrows g1 indicate anticlockwise circular polarized light that belongs to the wavelength band of light corresponding to green. The arrow r1 indicates anticlockwise circular polarized light that belongs to the wavelength band of light corresponding to red. The arrow r2 indicates clockwise circular polarized light that belongs to the wavelength band of light corresponding to red.

As illustrated in FIG. 11, the compound device 110 receives 0-degree linear polarized light B1, G1, and R1 and transmits the anticlockwise circular polarized light g1 and r1. The compound device 110 also receives 90-degree linear polarized light B2, G2, and R2 and transmits clockwise circular polarized light b2 and r2. As illustrated in FIG. 11, the liquid crystal panel 150 reflects the clockwise circular polarized light b2, the anticlockwise circular polarized light g1, and the clockwise circular polarized light r2.

Thus, like the above-described first embodiment, even a single-layer color display device can prevent degradation in display quality and reduce the cost of manufacturing a liquid crystal device. In addition, the design freedom for manufacturing a liquid crystal display device can be increased.

(2) Double-Layer Color Display Device

In the above-described first embodiment, the case is described in which a three-layered color display device in which three liquid crystal panels are layered is used. Alternatively, a double-layer color display device that includes two liquid crystal panels may be used. FIG. 12 is a diagram illustrating the reflection of light by a liquid crystal display apparatus according to the second embodiment.

As illustrated in FIG. 12, the color display device according to the second embodiment includes a liquid crystal panel 160 in which liquid crystals 160B and liquid crystals 160R are disposed dispersively and includes a liquid crystal panel 170 in which liquid crystals 170G and liquid crystals 170R are disposed dispersively.

The liquid crystal 160B illustrated in FIG. 12 reflects clockwise circular polarized light that belongs to the wavelength band of light corresponding to blue. Liquid crystals 160G and 170G reflects anticlockwise circular polarized light that belongs to the wavelength band of light corresponding to green. The liquid crystal 170R reflects anticlockwise circular polarized light that belongs to the wavelength band of light corresponding to red.

In the liquid crystal panel 160 and the liquid crystal panel 170, the characteristics of circular polarized light to be reflected are inverted between liquid crystal panels between which wavelength bands of light to be selectively reflected are adjacent to each other. Specifically, the characteristics of circular polarized light to be reflected are inverted between the liquid crystal 160B and the liquid crystal 160G and between the liquid crystal 170G and the liquid crystal 170R.

FIG. 12 illustrates a cross section of the compound device 110 and the color display device. The five arrows that are vertically drawn on the cross section indicate light transmission paths and light reflection paths. Among the five arrows in FIG. 12, the leftmost arrow indicates the light transmission path of linear polarized light having the 0-degree polarization direction.

The second leftmost arrow in FIG. 12 indicates the transmission path of linear polarized light having the 90-degree polarization direction. The third rightmost arrow and the second rightmost arrow indicate the reflection path of light that is reflected by the liquid crystal panel 160 or the liquid crystal panel 170. The rightmost arrow indicates the reflection path of light that is reflected by the liquid crystal panel 170.

Each of the arrows that are presented above the compound device 110 in FIG. 12 indicates any one of linear polarized light in each wavelength band having the 0-degree polarization direction and linear polarized light in each wavelength band having the 90-degree polarization direction.

For example, the arrow B1 that is presented above the compound device 110 in FIG. 12 indicates linear polarized light having the 0-degree polarization direction from light that belongs to the wavelength band of light corresponding to blue. The arrow B2 that is drawn above the compound device 110 indicates linear polarized light having the 90-degree polarization direction from light that belongs to the wavelength band of light corresponding to blue.

The arrow G1 that is presented above the compound device 110 in FIG. 12 indicates the linear polarized light having the 0-degree polarization direction from light that belongs to the wavelength band of light corresponding to green. The arrow G2 that is drawn above the compound device 110 indicates the linear polarized light having the 90-degree polarization direction from light that belongs to the wavelength band of light corresponding to green.

The arrow R1 that is presented above the compound device 110 in FIG. 12 indicates the linear polarized light having the 0-degree polarization direction from light that belongs to the wavelength band of light corresponding to red. The arrow R2 that is drawn above the compound device 110 indicates the linear polarized light having the 90-degree polarization direction from light that belongs to the wavelength band of light corresponding to red.

The curved arrows that are presented between the compound device 110 and the liquid crystal panels 160 and 170 in FIG. 12 indicate circular polarized light having predetermined characteristics.

For example, the arrow b2 that is presented between the compound device 110 and the liquid crystal panels 160 and 170 in FIG. 12 indicates clockwise circular polarized light that belongs to the wavelength band of light corresponding to blue. The arrow g1 indicates anticlockwise circular polarized light that belongs to the wavelength band of light corresponding to green. The arrow r1 indicates anticlockwise circular polarized light that belongs to the wavelength band of light corresponding to red. The arrow r2 indicates clockwise circular polarized light that belongs to the wavelength band of light corresponding to red.

As illustrated in FIG. 12, the compound device 110 receives 0-degree linear polarized light B1, G1, and R1 and transmits anticlockwise circular polarized light g1 and r1. As illustrated in FIG. 12, the compound device 110 also receives 90-degree linear polarized light B2, G2, and R2 and transmits the clockwise circular polarized light b2 and r2. As illustrated in FIG. 12, the liquid crystal panel 160 reflects the clockwise circular polarized light b2 and the anticlockwise circular polarized light g1. The liquid crystal panel 170 reflects the anticlockwise circular polarized light g1 and the clockwise circular polarized light r2.

Thus, like the above-described first embodiment, even a double-layer color display device can prevent degradation in display quality and reduce the cost of manufacturing a liquid crystal device. In addition, the design freedom for manufacturing a liquid crystal display device can be increased.

The liquid crystal display apparatus 100 can be widely applied to electric paper that is used for time tables on which time schedules of transport facilities are displayed and to price-display tags on which prices of goods are displayed in stores. In the electric paper, the predetermined control circuit applies a voltage to each liquid crystal panel in order to control each liquid crystal panel such that light is reflected or transmitted. In this manner, the display color of the electric paper is adjusted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display device comprising:
an optical device that absorbs non-linear light and non-linear light that are opposed to each other in at least two wavelength bands; and
a liquid crystal display device that selectively reflects non-linear polarized light transmitted by the optical device, in at least three wavelength bands,
wherein the optical device is disposed on a display surface of the liquid crystal display device.

2. The display device according to claim 1, wherein
the optical device includes
a first polarizer that polarizes light contained in incident light, in a first wavelength band to first linear polarized light;
a second polarizer that polarizes light contained in incident light, in a second wavelength band to a second linear polarized light; and
a phase difference plate that converts the first linear polarized light that is polarized by the first polarizer to first circular polarized light by adjusting the phase of the first liner polarized light and that converts the second linear polarized light that is polarized by the second polarizer to second circular polarized light by adjusting the phase of the second linear polarized light.

3. The display device according to claim 2, wherein
the liquid crystal display device includes
a first liquid crystal that reflects the first circular polarized light that belongs to the first wavelength band, transmits the second circular polarized light that belongs to a second wavelength band, and transmits the first circular polarized light and the second circular polarized light that belong to a third wavelength band;
a second liquid crystal that reflects the second circular polarized light that belongs to the second wavelength band and transmits the first circular polarized light and the second circular polarized light that belong to the third wavelength band; and
a third liquid crystal that reflects the first circular polarized light that belongs to the third wavelength band and transmits the second circular polarized light that belongs to the third wavelength band.

4. The display device according to claim 3, wherein
the liquid crystal display device includes
a liquid crystal reflective layer that includes the first liquid crystal;
a liquid crystal reflective layer that includes the second liquid crystal; and
a liquid crystal reflective layer that includes the third liquid crystal, and
the liquid crystal reflective layers are layered successively from the display surface of the liquid crystal display device.

5. The display device according to claim 3, wherein the liquid crystal display device includes a liquid crystal reflective layer in which the first crystal, the second crystal, and the third crystal are disposed dispersively.

6. The display device according to claim 3, wherein
the liquid crystal display device includes
a liquid crystal reflective layer in which the first crystal and the second crystal are disposed dispersively; and
a liquid crystal reflective layer in which the second crystal and the third crystal are disposed dispersively, and
the liquid crystal reflective layers are layered successively from the display surface of the liquid crystal display device.

7. A liquid crystal display apparatus, comprising:
a display device that includes an optical device that absorbs non-linear light and non-linear light that are opposed to each other in at least two wavelength bands; and a liquid crystal display device that selectively reflects non-linear polarized light in at least three wavelength bands, the optical device being disposed on a display surface of the liquid crystal display device; and
a control unit that controls the liquid crystal display device such that the liquid crystal display device reflects or transmit light.
